(19) United States
(12) Patent Application Publication
(10) Pub. No.: US 2002/0172310 A1
(43) Pub. Date: Nov. 21, 2002

(54) Jitter attenuator fifo overflow-underflow protection using digital-phase locked loop's bandwidth adaptation

(76) Inventors: Manop Thamsirianunt, Fremont, CA (US); Tony Wong, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/860,906

(22) Filed: May 18, 2001

(51) Int. Cl. H04L 7/00

(52) U.S. Cl. 375/371; 375/376

(57) ABSTRACT

The present invention provides a jitter attenuator that has a phase locked loop (PLL), the PLL having a programmable bandwidth setting. The jitter attenuator also has a first-in/first-out (FIFO) buffer for storing data, a write clock for providing a write pulse to the FIFO, a read clock for providing a read pulse to the FIFO, and a pointer generator for controlling the programmable bandwidth in response to the difference between the frequencies of the write and read clocks.

### BACKGROUND OF THE INVENTION

The present invention relates in general to the design of integrated circuits, hardware and systems, and in particular to methods of protecting a jitter attenuator First-In/First-Out (FIFO) buffer from data overflow and underflow conditions in digital data communications.

Data transmission of a digital signal involves interfacing between at least two different systems with at least two different clock sources. When data regenerating, multiplexing, and de-multiplexing take place, timing inaccuracy known as “jitter” often results. Jitter embedded in the data transmission signal has properties in both frequency (Hertz) and amplitude (Unit Interval or UI), whereby 1 UI equals one clock period. Jitter is the short-term variation of a digital signal's significant instants from their ideal position in time. If the jitter's frequency is significantly low enough, its effect can be considered as if the frequency of the clock is being increased or decreased depending on which polarity that clock is modulated. On the positive cycle of the jitter signal, the clock will run faster. On the negative cycle, the clock will run slower. If the amount of jitter is large (high amplitude), the maximum frequency deviation from the main clock's center frequency will be proportionally larger.

In most cases, jittery data results from a jittery clock and is associated with timing generation. In another case, long-range regenerated data can induce jittery recovered clock. Before the data is processed by subsequent systems, the level of induced jitter is kept below certain telecommunication timing jitter requirements.

To eliminate or reduce the jitter, a jitter attenuator can be inserted between the system's transmit or receive path. A common practice for removing the jitter is the use of a low bandwidth PLL (phase lock-loop) combined with a digital data storage element such as a FIFO or elastic storage device to function as a jitter attenuator. The FIFO absorbs the jitter by sequentially buffering the incoming data that is being written into the FIFO by its associated jittery clock. The low-bandwidth PLL is needed and must be phase locked to the incoming clock in order to keep the length of a storage element to a realizable size such as 64 or 128 bits. During the read process, buffered data is sequentially read out by a stable jitter-free clock derived from the output of the PLL. During the write/read process, however, the FIFO's depth plays the most critical role in preventing the FIFO from having an overflow or underflow condition. In the case of an overflow condition, the FIFO runs out of storage space causing the new incoming data bits to override the previous ones. Conversely, if write process is too slow due to the slow write clock frequency (induced negative polarity of jitter), the data read process introduces an under-run condition. Both cases can result in a catastrophic data corruption or a transmission interruption.

In most telecommunications systems with jitter attenuation, it is common to build in extra FIFO depth to prevent data underflow or overflow. In addition to the expense of more hardware to prevent these conditions, a longer FIFO can present a latency problem because each added data storage element adds the read and write cycle time.

What is needed is a design or architecture scheme that can adequately absorb a large amount of jitter amplitude while maintaining a limited FIFO length. The new scheme should tolerate a substantial amount of jitter before data corruption occurs. The scheme should also limit data throughput latency while maintaining data integrity and preventing FIFO overflow and underflow conditions.

### SUMMARY OF THE INVENTION

The present invention achieves the above needs with a new jitter attenuator using adjustable phase-locked bandwidths to prevent FIFO overflow and underflow conditions. More particularly, the present invention provides a jitter attenuator that has a phase locked loop (PLL), the PLL having a programmable bandwidth setting. The jitter attenuator also has a first-in/first-out (FIFO) buffer for storing data, a write clock for providing a write pulse to the FIFO, a read clock for providing a read pulse to the FIFO, and a pointer generator for controlling the programmable bandwidth in response to the difference between the write and read clocks' frequencies.

Embodiments of the invention include a FIFO read/write positioning system which determines the locations of a FIFO's read and write pointers and include a PLL whose bandwidth can be adjusted by a programming method. When the FIFO approaches overflow/underflow condition, determined by the read and write pointer location, the PLL automatically adjusts its bandwidth to a much higher frequency to keep up with the jitter amplitude and offset frequencies. Although the jitter attenuation effect at low frequency diminishes, data can be continually read out of the FIFO without interruption even as the FIFO approaches an overflow or underflow condition.

In another embodiment, the pointer generator provides a write pointer, a read pointer, a first pulse, a second pulse, and a sample pulse. The first and second pulses are derived from the write pulse, the sample pulse being derived from the read pulse. The pointer generator compares relative locations of the pulses and the pointer generator sends a signal to the PLL for adjusting the programmable bandwidth setting when one of the first and second pulses overlaps the sample pulse. Also, the speed of the read pointer tracks the speed of the write pointer.

The present invention achieves the above purposes and benefits in a simple, versatile, and reliable circuit and method that is readily suited to the widest possible utilization. The present invention achieves these purposes and benefits in the context of known circuit technology and known techniques in the electronic arts. Further understanding, however, of the nature, objects, features, and advantages of the present invention is realized by reference to the latter portions of the specification, accompanying drawings, and appended claims. Other objects, features, and advantages of the present invention will become apparent upon consideration of the following detailed description, accompanying drawings, and appended claims.

### BRIEF DESCRIPTION OF THE DRAWINGS

FIG. 1 shows a simplified high-level block diagram of a conventional jitter attenuator system;

FIG. 2 shows a simplified high-level block diagram of a jitter attenuator system having a FIFO overflow-and-underflow protection scheme, according an embodiment of the present invention;

FIG. 3 shows a simplified timing diagram according to the present invention; and

FIG. 4 shows a simplified high-level block diagram of a FIFO read-write pointer generator of FIG. 2, according an embodiment of the present invention.

### DESCRIPTION OF THE SPECIFIC EMBODIMENTS

With reference to the drawings, the new and improved jitter attenuator having a first-in/first-out overflow-underflow protection scheme, according to the present invention, is described below.

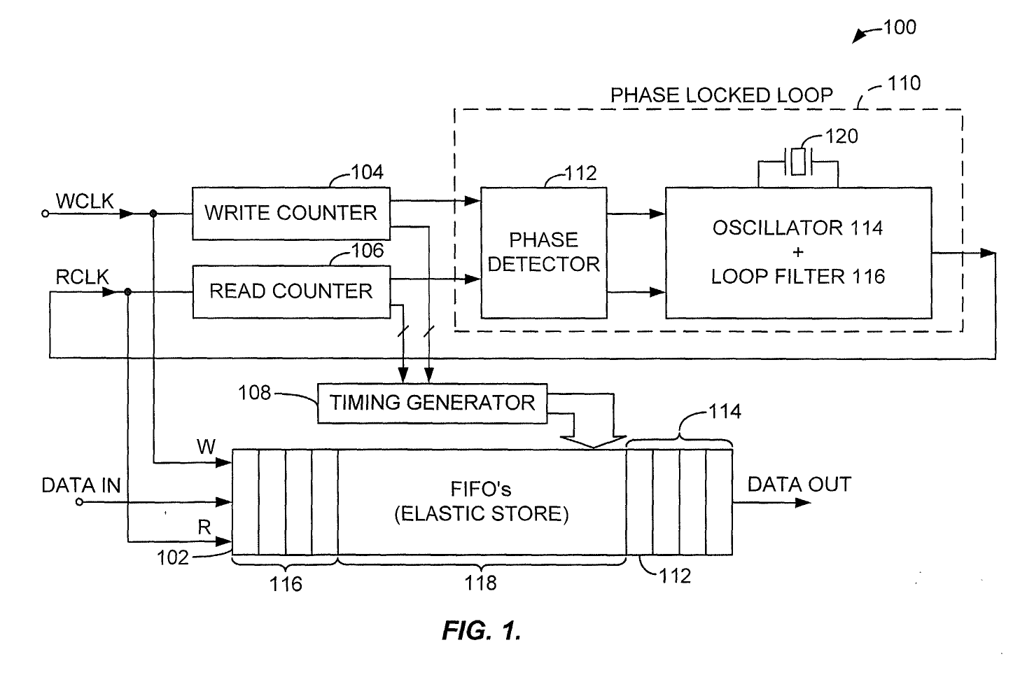

FIG. 1 shows a simplified high-level block diagram of a conventional jitter attenuator system 100. The jitter attenuator system shown includes a first-in/first-out (FIFO) memory 102, a write counter 104, a read counter 106, a timing generator 108, and a phase locked loop (PLL) 110 (shown in dashed box).

In operation, write clock 104 sequentially shifts, or “writes,” data bits to FIFO 102, and read clock 106 later sequentially shifts, or “reads,” data from FIFO 102. Read clock 106 is also called a “jitter-free” read clock because its signal is generated internally with respect to a clean clock source such as a crystal oscillator. Read clock 106 is not affected by jitter, and is thus stable and predictable. It ideally reads data bits out and attenuates or eliminates the data's jitter. Write and read clocks 104 and 106 also provide synchronization for PLL 110. Timing generator 108, also called a pointer generator, provides the basic timing signal for the FIFO registers. Specifically, the timing generator determines the specific FIFO registers to and from which the data is written and read, respectively. Counters and timing generators are well-known in art. PLL 110 is described in more detail further below.

Note that, for ease of illustration, a single string of bits is described as being written to and read from the FIFO. In practice, however, multiple strings, or “rails,” of bits are written to and read from the FIFO, in parallel, such that data words pass through the FIFO. These rails use the same write and read clocks so that they are synchronized. Also, because they are synchronized, all bits in same data word experience the same jitter.

FIFOs are well-known in the art. A FIFO's operation is described as follows. The write clock directs a write pointer to a specific register into which a data bit is written. Ideally, this register is empty. The write pointer then moves to a subsequent register to write in the next incoming data bit. Likewise, The read clock directs a read pointer to a specific register from which a data bit is read. Ideally, this register contains a bit to be read. The read pointer then moves to a subsequent register read the next outgoing data bit.

As mentioned above, jitter in the data signal typically causes jitter in the write clock. As is well-known, jitter causes the write clock frequency to increase or decrease, and thus the write pointer thus moves faster or slower, respectively, from register to register. The write pointer moves faster during the positive cycle of a modulated jitter and moves slower during the negative cycle. The read clock frequency remains constant and thus moves from register to register at a constant rate. Such jitter can cause data overflow and underflow conditions. A larger jitter amplitude in the data causes more extreme overflow and underflow conditions.

Data overflow and underflow conditions are well-known in the art. Generally, data overflow is the condition where data written to a FIFO exceeds the FIFO's capacity such that part of the data cannot be stored. For example, the write clock might attempt to write data into a FIFO not having enough capacity. Specifically, the write clock frequency is much faster than that of the read clock such that the write pointer catches up to the read pointer. In other words, data is written into the FIFO faster than data is read out of the FIFO.

Generally, data underflow is the condition where there is not enough data in the FIFO. For example, the read clock might attempt to read from a particular FIFO register but the required bit had not yet been stored in that register. Specifically, the write clock frequency is much slower than that of the read clock such that the read pointer catches up to the write pointer. In other words, data is read from the FIFO faster than data is written into the FIFO.

FIFOs are useful in buffering asynchronous data. For example, referring still to FIG. 1, empty data registers are added between the write and read pointers to absorb jitter. More registers could be added to absorb greater jitter amplitudes. Accordingly, it would require more write/read cycles for the write pointer to catch up to the read pointer, or for the read pointer to catch up to the write pointer. By then, the jitter amplitude might have decreased. For optimum jitter tolerance, write pointer is typically set at one half the FIFO length apart from the read pointer. This distance is known in the art as the “elastic store” 118. This elastic store acts as a buffer zone. Under normal operating conditions, FIFO 102 can absorb jitter amplitude having a magnitude of up to half of the FIFO's length. The maximum jitter amplitude is measured in unit intervals (UI). One UI is typically one FIFO register, or one bit, in length. In the example of FIG. 1, the FIFO length is 32 UI. The data can thus have a maximum jitter amplitude of ±16 UI. If the jitter amplitude exceeds ±16 UI, a data overflow and underflow abruptly occurs. To absorb jitter, the FIFO length must be increased. A FIFO that is too long, however, requires more hardware and takes up space. Also, it can cause too much elasticity and thus too much latency which is an undesirable design characteristic.

Phase locked loop (PLL) 110 includes a phase detector 112, a voltage-controlled oscillator (VCO) 114, a LLP filter 116, and a crystal oscillator 120. PLL 110 has a low-bandwidth that is fixed.

PLLs are well-known in the art. Generally, a PLL is a system in which a local oscillator synchronizes, or “tracks,” in phase and frequency with a reference signal. Specifically, referring still to FIG. 1, phase detector 112 compares the phase of two input signals, one from clock 104, one from clock 106. Phase detectors, also called phase discriminators, are well-known in art. Detector 112 then generates and outputs a dc signal with information regarding the phase difference between the two input signals. The output dc signal is also known as a “correction signal” or an “error signal.” The correction voltage then feeds to VCO 114 via LLP filter 116, also called counter 116. Filter 116 is a counter that generates and sends signals to oscillator 114. The signals instruct the oscillator to speed up or slow down depending on the phase difference between the two input signal frequencies. VCO 114 generates, using crystal oscillator 120, a digital output having a frequency proportional to the amplitude of the correction voltage. VCOs are well-known in art. This output signal from VCO 114 then feeds back to phase detector 112. This continues until the two signals are equal, or “locked,” in phase and frequency.

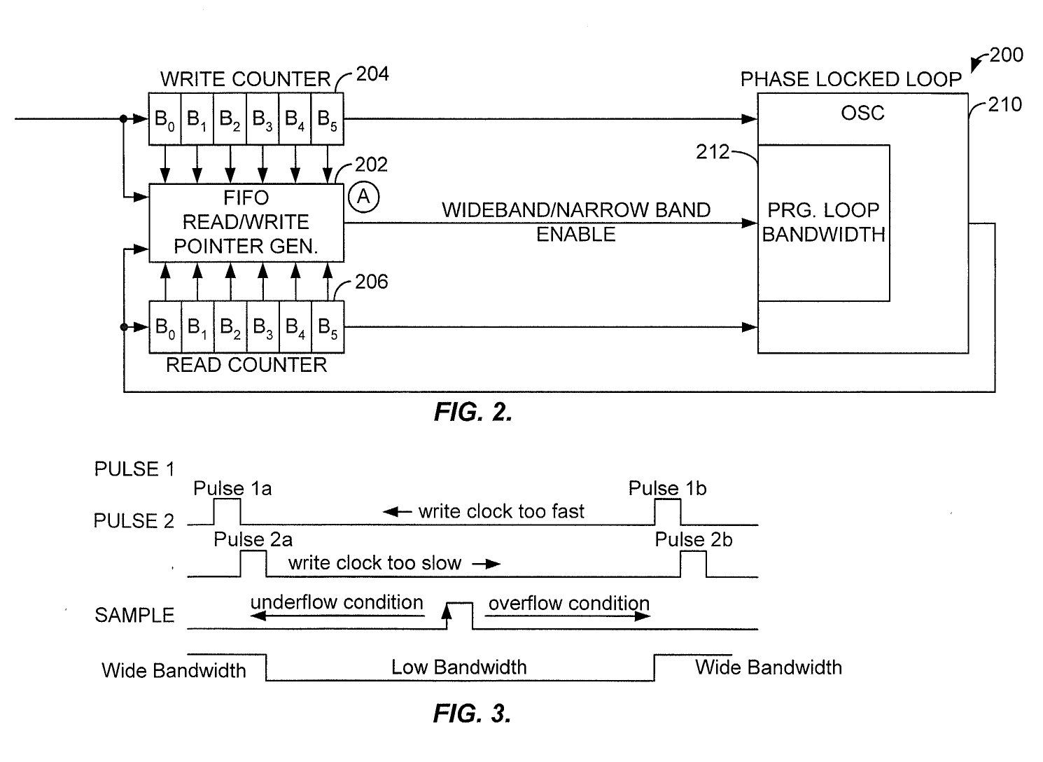

FIG. 2 shows a simplified high-level block diagram of a jitter attenuator system 200 having a FIFO overflow-and-underflow protection scheme, according an embodiment of the present invention. This diagram is merely an example and should not limit the scope of the claims herein. One of ordinary skill in the art would recognize many other variations, modifications, and alternatives. Also, the described system and method can be implemented in a multitude of different forms (i.e., software, hardware, or a combination of both such as with programmable logic) in a variety of systems. In a specific embodiment, jitter attenuator system 200 shown includes a programmable FIFO read-write pointer generator 202, a write clock 204, a read clock 206, and a digital PLL 210 with a programmable bandwidth setting 212.

In operation, generally, the write and read clocks track together even with the jitter. In a specific embodiment, the write clock 204 becomes the reference counter such that the frequency of the read counter follows that of the write counter. Pointer generator 202 tracks the write and read counters and constantly monitors the relative position of write and read clocks. Specifically, write clock 204 sequentially writes data bits to the FIFO, and read clock 206 later sequentially reads data from the FIFO. Write and read clocks 204 and 206 also provide the write and read timing sequence for PLL 210. Pointer generator 202 changes the bandwidth setting of PLL 210. The protection scheme according to the present invention improves upon the jitter attenuator architecture of FIG. 1 in two primary ways. First, the scheme of FIG. 2 incorporates pointer generator 202 for changing PLL bandwidth setting 212. Second, the scheme employs PLL 210 with programmable bandwidth 212. Note that pointer generator also performs the function of a timing generator embedded in to the timing generator of FIG. 1.

In a specific embodiment, clocks 204 and 206 are divide-by-64 counters. This allows for an elastic store of up to 32 UI. Clocks 204 and 206, however, can be other divide-by-N counters, and the like. For example, 32 bit counters can be used which would allow for an elastic store of up to 32 UI.

FIG. 3 shows a simplified timing diagram according to the present invention. “Pulse 1” and “pulse 2” are derived from, and track, the write pulse provided by write clock 204. Pulses 1 and 2 would thus move together. A reference, or “sample pulse,” is derived from, and tracks, the read pulse provided by read clock 206. Specifically, the sample pulse is derived from the opposite phase of the read clock, because it is the optimum position for aligning the read and write pointers for optimum jitter tolerance. Thus, using logic circuits, these pulses can be compared to indicate the relative positions of the write and read pointers.

While more jitter is undesired when using conventional attenuators, the jitter attenuator of the present invention allows more jitter without having to increase the FIFO length to prevent data corruption. Pointer generator 202 tracks the relative positions of pulses 1 and 2, and the sample pulse. Referring still to FIG. 3, when jitter causes the write pointer to move faster than the read pointer, pulses 1 and 2 move to the left, relative to the sample pulse. Recall that pulses 1 and 2 move together. Also, note the relative positions of pulses 1 and 2. In this example, pointer generator monitors pulse 1b. The closer pulse 1b gets to the sample pulse, the closer the write pointer is to catching up to the read pointer. Recall that when the write pointer overtakes the read pointer, an overflow condition occurs. When pulse 1b begins to overlap the sample pulse, before an overflow condition occurs, pointer generator 202 causes programmable PLL bandwidth 212 to increase. This increases the speed of the read pointer, preventing the write pointer from catching up.

Conversely, when jitter causes the write pointer to move slower than the read pointer, pulses 1 and 2 move to the right, relative to the sample pulse. In this example, pointer generator monitors pulse 2a. The closer the pulse 2a gets to the sample pulse, the closer the read pointer is to catching up to the write pointer. Recall that when the read pointer overtakes the write pointer, an underflow condition occurs. When pulse 2a begins to overlap the sample pulse, before an underflow condition occurs, pointer generator causes the programmable PLL bandwidth to increase. When the bandwidth is wider, the read pointer slowing itself down to allow the write pointer to catches up, preventing the FIFO from being in an underflow position.

The bandwidth of PLL 210 determines how much the jitter attenuator reduces jitter at a particular frequency of jitter. Generally, a low bandwidth more effectively reduces jitter by rejecting much of the jitter at high frequencies. Also, a high bandwidth increases the rate of counter 116 and thus the update rate of PLL 210. While this allows more jitter at high frequencies to enter attenuator 200, it also increases the speed of the read pointer. An overflow condition is prevented because the read pointer would keep up with the write pointer.

In a specific embodiment, the phase locked loop defaults to a low frequency. This low frequency setting is adequate for absorbing jitter which might cause an underflow condition. If either pulse 1 or pulse 2 overlap with the sample pulse, pointer generator 202 sends a correction signal to PLL 210 to instantly increase the bandwidth setting appropriately for as long as the overflow or underflow condition exists. However, during high-bandwidth mode, the jitter attenuation effect is not enabled. Once the overflow or underflow condition subsides, the PLL bandwidth setting 212 defaults to the original low bandwidth setting. Both pulse 1 and pulse 2 have a pulse width of two clock cycles, or 2 unit intervals. This wider pulse width allows pointer generator 202 to trigger a higher PLL bandwidth setting when the FIFO is on the verge of but before an actual overflow or underflow condition to occur. Under normal conditions, where low amplitude jitter is introduced to the data, the PLL locks to the write clock, the phases of which is synchronized with that of read clock. A low bandwidth is preferred because it would attenuate most jitter conditions. In yet another embodiment, there could be no default bandwidth, where the bandwidth is always controlled by pointer generator 202.

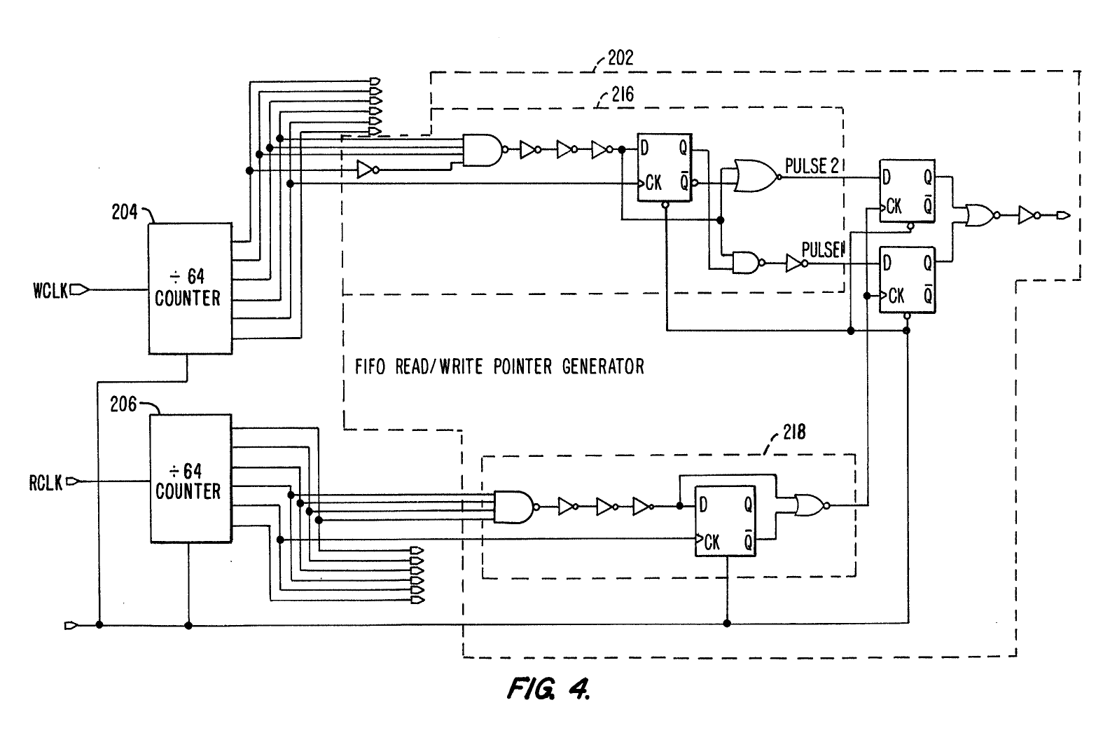

FIG. 4 shows a simplified high-level block diagram of a FIFO read-write pointer generator 202 of FIG. 2, according an embodiment of the present invention. This diagram is merely an example and should not limit the scope of the claims herein. One of ordinary skill in the art would recognize many other variations, modifications, and alternatives. Also, the described system and method can be implemented in a multitude of different forms (i.e., software, hardware, or a combination of both) in a variety of systems. In a specific embodiment, a first pointer generator 216 receives a write pulse from write clock 204 to generate pulse 1 and pulse 2. Also, a second pointer generator 218 receives a read pulse from read clock 206 to generate the sample pulse. Pointer generator 202 then compares the locations of pulses 1 and 2, and the sample pulse the determine whether to send a correction signal to PLL bandwidth setting 212 (FIG. 2). Pointer generators, such as first and second pointer generators 216 and 218, are well-known in the art. Logic circuits such as those shown in FIG. 4 are also well-known in the art.

Specific embodiments of the present invention are presented above for purposes of illustration and description. The full description will enable others skilled in the art to best utilize and practice the invention in various embodiments and with various modifications suited to particular uses. After reading and understanding the present disclosure, many modifications, variations, alternatives, and equivalents will be apparent to a person skilled in the art and are intended to be within the scope of this invention. Therefore, it is not intended to be exhaustive or to limit the invention to the specific embodiments described, but is intended to be accorded the widest scope consistent with the principles and novel features disclosed herein, and as defined by the following claims.

What is claimed is:

1. A jitter attenuator comprising:
a phase locked loop (PLL), the PLL having a programmable bandwidth setting;
a first-in/first-out (FIFO) buffer for storing data;
a write clock for providing a write pulse to the FIFO;
a read clock for providing a read pulse to the FIFO; and
a pointer generator for controlling the programmable bandwidth in response to the difference between the frequencies of the write and read clocks.

2. The jitter attenuator of claim 1 wherein the pointer generator provides a write pointer, a read pointer, a first pulse, a second pulse, and a sample pulse, the first and second pulses being derived from the write pulse, the sample pulse being derived from the read pulse, the pointer generator comparing relative locations of the pulses, the pointer generator sending a signal to the PLL for adjusting the programmable bandwidth setting when one of the first and second pulses overlaps the sample pulse, the speed of the read pointer tracking the speed of the write pointer.

3. The jitter attenuator of claim 2 wherein the first pulse overlaps the sample pulse when the FIFO is on the verge of an overflow condition.

4. The jitter attenuator of claim 2 wherein the second pulse overlaps the sample pulse when the FIFO is on the verge of an underflow condition.

5. The jitter attenuator of claim 1 wherein the write and read clocks are counters.

6. The jitter attenuator of claim 1 wherein the pointer generator further comprises:
a write circuit for generating the first and second pulses; and
a read circuit for generating the sample pulse.

7. A method for attenuating jitter in an integrated circuit, the method comprising:
storing data in a first-in/first-out (FIFO) buffer;
providing a write pulse to the FIFO, with a write clock;
providing a read pulse to the FIFO, with a read clock;
taking difference between the frequencies of the write and read clocks; and
controlling a programmable bandwidth, with a pointer generator, in response to the difference between the frequencies of the write and read clocks.

8. A method for attenuating jitter in an integrated circuit, the method comprising:
storing data in a first-in/first-out (FIFO) buffer;
providing a write pulse to the FIFO, with a write clock;
providing a read pulse to the FIFO, with a read clock;
providing a read pointer and a write pointer;
determining the location of the read pointer and the location of the write pointer; and
adjusting the bandwidth of a PLL to higher frequency, when the FIFO approaches an overflow or underflow condition, to keep up with jitter amplitude and offset frequencies.

9. The jitter attenuator of claim 8 wherein data is continually read out of the FIFO without interruption even as the FIFO approaches an overflow or underflow condition.

10. The jitter attenuator of claim 8 wherein the frequency of the bandwidth is increased by a factor of at least 10.

11. The jitter attenuator of claim 8 wherein the adjusting is immediate.

12. A method for attenuating jitter in an integrated circuit, the method further comprising:
providing a write pointer and a read pointer, with the pointer generator;
providing a first pulse and a second pulse, with the pointer generator, wherein the first and second pulses are derived from the write pulse;
providing a sample pulse, with the pointer generator, wherein the sample pulse is derived from the read pulse;
comparing relative locations of the pulses, with the pointer generator; and
sending a signal to the programmable bandwidth setting, with the pointer generator, to the PLL for adjusting the programmable bandwidth setting when one of the first and second pulses overlaps the sample pulse, wherein the speed of the read pointer tracks the speed of the write pointer.
